(19) United States
(12) Patent Application Publication
(10) Pub. No.: US 2016/0355706 A1
(43) Pub. Date: Dec. 8, 2016

(54) Double-Sided Self-Adhesive Products with High Optical Quality

(71) Applicant: Tesa SE, Norderstedt (DE)

(72) Inventors: Thilo DOLLASE, Hamburg (DE); Matthias KOOP, Norderstedt (DE); Ralph SCHREIBER, Hamburg (DE)

(21) Appl. No.: 15/240,737

(22) Filed: Aug. 18, 2016

Related U.S. Application Data
(62) Division of application No. 13/642,313, filed on Nov. 15, 2012.

(30) Foreign Application Priority Data
Apr. 26, 2010 (DE) 10 2010 028 184.0

(51) Int. Cl. C09J 7/02; B29C 65/50; B32B 37/24; B32B 27/08; B32B 37/14; B32B 37/00; B32B 37/12; B29C 65/52; B29C 65/00; B29C 65/48; C09J 5/00; B32B 7/12

(52) U.S. Cl. CPC C09J 7/0267; C09J 5/00; C09J 7/0246; B29C 65/50; B32B 37/24; B32B 27/08; B32B 7/12; B32B 37/025; B32B 37/1284; B29C 65/52; B29C 66/45; B29C 66/712; B29C 66/733; B29C 65/4825; B32B 37/144; B32B 37/12; C09J 133/00

(57) ABSTRACT

The invention relates to a double-sidedly pressure-sensitively adhesive product having a haze value (measured by test method B) of 5% or less, comprising a carrier having a first surface and a second surface, and also a first layer of pressure-sensitive adhesive, disposed on the first surface of the carrier, and a second layer of pressure-sensitive adhesive, disposed on the second surface of the carrier, characterized in that the carrier has a modulus of elasticity of 2.5-500 MPa.

The present invention relates to double-sidedly pressure-sensitively adhesive products having a haze value of 5% or less, comprising a carrier having a first surface and a second surface, and also a first layer of pressure-sensitive adhesive, disposed on the first surface of the carrier, and a second layer of pressure-sensitive adhesive, disposed on the second surface of the carrier, where the carrier has a modulus of elasticity of 2.5-500 MPa. The invention further embraces the use of products of the invention in the adhesive bonding of optical components, i.e. in the bonding of components where at least one of the components is transparent and the components are rigid (e.g., glass) or flexible (e.g., films), and also articles comprising components bonded with a double-sidedly pressure-sensitively adhesive product of the invention.

### PRIOR ART

In certain adhesive bonds of optical components there are constructional interlayer distances of up to 500 μm or more that must be filled out physically by adhesives without any air inclusions occurring. For this purpose it is possible in principle to employ liquid adhesives, adhesive transfer tapes, and double-sided adhesive tapes with carrier.

The employment of liquid adhesives is associated with problems of optical quality and also with problems in adhesive bonding, namely the handling qualities themselves. For instance, during their employment, there may be formation of bubbles or there may be contraction, and this greatly reduces the optical quality. The curing procedure necessary with liquid adhesives complicates and prolongs the adhesive bonding operation, moreover.

Double-sidedly self-adhesive products such as adhesive transfer tapes and double-sided adhesive tapes with carrier are distinguished by greater ease of handling and of processing. Their great benefit in areas of application of connective bonding comes about, in the case of corresponding adhesives, from the pressure-sensitive adhesiveness of the product surfaces and from the fact that the adhesives used do not have to cure after application.

Prior-art double-sided adhesive tapes with carrier, suitable for optical applications on the basis of their characteristics, comprise rigid carrier materials such as polyesters, for example. Since such carriers are relatively rigid, the capacity of the overall adhesive product to conform is too low, and air inclusions develop at the transition from flat to raised areas. These problems are exacerbated when attempts are made to use these products to compensate topographical features. As well as the function of filling out application-specific spaces in a physically connecting way, however, there has for some time been an increase in the imposition on double-sidedly self-adhesive products of particularly those requirements whereby the adhesive product is supposed to compensate topographical features of the substrates to be bonded. Reference may be made in this connection to topographical features of the components or surfaces to be bonded, such as waviness, roughness, curvature, bending, and structurings of any kind. The topographical differences to be compensated may lie in the region of a few 10 nm (roughness) up to several 100 μm (curvature, bending). The employment of conventional double-sided adhesive tapes with carrier is ruled out here by the stiffness of typical carrier materials in the stated applications, in the case of relatively large topographical differences.

Topographical features of the substrates to be bonded can be compensated more effectively by (carrier-free) adhesive transfer tapes. Known adhesive transfer tapes are capable of compensating topographical differences in the region of a few 10 nm (roughness) up to about 100 μm.

The use of adhesive transfer tapes in optical applications for compensating sizable topographical differences of up to 500 μm or more is thwarted, however, by the availability of suitable adhesive transfer tapes having such layer thicknesses and/or by optical problems resulting from the methods used to produce the stated adhesive transfer tapes. Adhesive transfer tapes of this thickness are customarily produced without solvent. Coating results of the highest optical quality are not accessible in this way. Furthermore, with adhesive transfer tapes of high layer thickness, problems occur in respect of their processing properties if coating takes place from solution. Accordingly, the drying rate of the adhesive transfer tapes in the production operation correlates with the layer thickness, producing low drying rates at high layer thicknesses. Furthermore, in the further processing of adhesive transfer tapes with high layer thicknesses, in diecutting operations, for example, there are technical difficulties. One reason for this is the increased tendency on the part of the adhesive toward oozing. In the case of adhesive transfer tapes of high layer thickness there is also an increase in side-edge stickiness, which in turn hinders handling and further processing.

Consequently there is a need to provide products of high optical quality which on the one hand are able to fill out constructural interlayer spaces and also to compensate for topographical differences when bonding optical components, without any air inclusions occurring, and on the other hand ensure good processing qualities such as reduced adhesive oozing tendency and good diecuttability.

### INVENTION

To solve the stated problems, the present invention proposes double-sidedly pressure-sensitively adhesive products having a haze value of 5% or less, comprising a carrier having a first surface and a second surface, and also a first layer of pressure-sensitive adhesive, disposed on the first surface of the carrier, and a second layer of pressure-sensitive adhesive, disposed on the second surface of the carrier, where the carrier has an elasticity modulus of 2.5-500 MPa. In other words, the present invention relates to double-sidedly pressure-sensitively adhesive products for high-grade optical applications, having a carrier and a first layer of pressure-sensitive adhesive disposed on the facing side of the carrier, and also having a second layer of pressure-sensitive adhesive disposed on the reverse side of the carrier, with the carrier having the stated modulus of elasticity. The modulus of elasticity (determined in accordance with test method A) indicates the mechanical resistance with which a material opposes an elastic deformation.

In one preferred embodiment of the invention, the carrier of pressure-sensitively adhesive products of the invention has a modulus of elasticity of 5-250 MPa. In a likewise preferred embodiment, the double-sidedly pressure-sensitively adhesive products of the invention have a haze value of not more than 2%. When the modulus of elasticity of the carrier of products of the invention is situated within the stated range of 2.5-500 MPa, preferably 5-250 MPa, the capacity to conform to a given substrate surface topography is very advantageous and is achieved in combination with a further reduced tendency toward oozing of adhesive.

The tendency toward oozing of adhesive (in this regard see test C) for products of the invention is not more than 10%. If the oozing ratio OR (measured by test method C) is above this level, there is already a pronounced side-edge stickiness.

The carrier of pressure-sensitively adhesive products of the invention may have a single-layer or multilayer construction, and so pressure-sensitively adhesive products of the invention have at least one carrier layer. The at least one carrier layer may be constructed from a single ply of material or from two or more. Any such multilayeredness/multi-plyedness may be the result of a laminating operation on a variety of individual plies and/or else may be the result of a coextrusion operation, to name only two examples. Where two or more carrier layers are employed, the surfaces directed toward one another in each case may be directly in contact or may be joined to one another via one or more interlayers such as further pressure-sensitive adhesive layers or else other adhesive layers such as heat-seal or cold-seal layers. The carrier of pressure-sensitively adhesive products of the invention is preferably single-layer.

The carrier of the double-sidedly pressure-sensitively adhesive products has a layer thickness of between 4 μm and 1000 μm, more preferably between 25 μm and 250 μm. In one embodiment of the invention the carrier used comprises films, and it is also possible for other suitable carrier materials such as free-standing viscoelastic or elastic coating layers to be used. It is possible to employ more than one carrier film, in which case the films may be selected independently of one another in respect of raw materials class, formulation, chemical properties, physical properties, surface treatment and/or thickness. The films used as carriers may have been monoaxially or biaxially oriented or else may be employed in an unoriented state.

With regard to the selection of materials, there are no particular restrictions on the carriers, provided they ensure a modulus of elasticity of 2.5-500 MPa, preferably 5-250 MPa, and a haze value of 5% or less, preferably 2% or less, in the pressure-sensitively adhesive product of the invention. Suitable base material for carriers comprises thermoplastic and nonthermoplastic elastomers which, either alone or in combination with any further adjuvants, meet the criteria of the modulus of elasticity and of the optical properties. The elastomers have a high elastic component. This component is preferably at least 80%, preferably at least 90%, although a viscoelastic behavior with a lower elastic component is also possible. The elastic component of the double-sidedly pressure-sensitively adhesive products is likewise preferably at least 80%, very preferably at least 90%, although here again a viscoelastic behavior with a lower elastic component is possible.

The base material for the carriers of the products of the invention has at least one phase which has a softening temperature of below 25° C., preferably of below 0° C., called the elastomer phase or soft phase. Very preferably this phase is present at more than 25% by weight and, by virtue of mixing or of chemical incorporation, is part of the base material of the at least one carrier layer.

The group of the nonthermoplastic elastomers which can be used in the carrier comprises, in particular, chemically crosslinked (co)polymers. Appropriate modes of crosslinking include all of the approaches known to the skilled person for the production of elastomers/rubbers. Examples include covalent crosslinking via reactions between functional groups which are present in the (co)polymers and crosslinkers. Available to the developer for this purpose are all of the crosslinking approaches from the chemistry of rubbers, coatings, thermosets, paints, and adhesives. It is advantageous to use polyfunctional crosslinker molecules—bifunctional, for example. These molecules may be isocyanates, epoxides, silanes, anhydrides, aziridines or melamines. Furthermore, peroxide-based crosslinkers can be used, and vulcanizing systems. G. Auchter et al. indicate a series of crosslinking approaches which can also be used advantageously for the carrier for the purposes of this invention (G. Auchter et al. in Handbook of Pressure-Sensitive Adhesive Technology, D. Satas (ed.), 3^{rd} edn., 1999, Satas & Associates, Warwick, pp. 358-470 and literature cited therein).

Very advantageous within the group of the nonthermoplastic elastomers are chemically crosslinked (meth)acrylate copolymer-based elastomers which through appropriate choice of the (meth)acrylate monomers exhibit an inventively low softening temperature and comprise functional comonomers which are capable of a chemical reaction with crosslinkers. U.S. Pat. No. 3,038,886 indicates an example of a chemically crosslinked polyacrylate elastomer, where ethyl acrylate has been copolymerized with 2-hydroxyethyl methacrylate. 2-Hydroxyethyl methacrylate offers with the OH group a functional group via which a covalent bond is developed with a crosslinker (in this case, acid anhydride). Furthermore, coordinative (for example, forming multidentate complexes, such as metal chelates) and ionic (for example, forming ion clusters) crosslinking modes are possible, provided they have sufficient stability. Also possible are chemical crosslinking methods initiated by radiation. These include, in particular, crosslinking reactions initiated by UV rays and/or electron beams. In addition to (meth)acrylic comonomers, (meth)acrylate copolymers may also include other comonomers, especially vinylic comonomers.

The higher the degree of crosslinking, the higher, too, the modulus of elasticity for the resulting elastomers. Via the degree of crosslinking it is therefore possible to adjust the elastic properties of the nonthermoplastic elastomers in accordance with the requirements for the purposes of this invention.

As nonthermoplastic elastomers it is also advantageous to use rubber-based materials for the carrier of products of the invention, in order to realize the desired elastic properties. Although rubbers as well can be chemically crosslinked, they can also be used without additional crosslinking if their molar masses are sufficiently high (as is the case for many natural and synthetic systems). The desired elastic properties result in long-chain rubbers from the interloops, or from the interloop molar masses, which are polymer-characteristic (with regard to the approach and for a series of polymers, see L. J. Fetters et al., Macromolecules, 1994 27, 4639-4647). Where rubber or synthetic rubber or blends produced therefrom are employed as base material for the at least one carrier layer, then the natural rubber may in principle be selected from all available grades such as, for example, crepe, RSS, ADS, TSR or CV types, depending on required level of purity and of viscosity, and the synthetic rubber or rubbers may be selected from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA), and polyurethanes, and/or from blends thereof. The mandate for the selection of such materials for carrier systems of products of the invention is agreement with the mandates concerning the optical quality in accordance with this invention.

Without wishing to be limited by this listing, the group of the thermoplastic elastomers that can be used for the carrier of products of the invention includes semicrystalline polymers, ionomer-containing polymers, block copolymers, and segmented copolymers. Specific examples of thermoplastic elastomers are thermoplastic polyurethanes (TPU). Polyurethanes are chemically and/or physically crosslinked polycondensates which are typically synthesized from polyols and isocyanates and which typically comprise soft segments and hard segments. The soft segments are composed, for example, of polyesters, polyethers, polycarbonates, each preferably aliphatic in nature in accordance with this invention, with polyisocyanate hard segments. Depending on the nature of the individual components and the proportions in which they are used, materials are obtainable which can be used advantageously for the purposes of this invention. Raw materials available to the formulator for this purpose are identified for example in EP 894 841 B1 and EP 1 308 492 B1. Lycra® from DuPont, Estane®, Mobay Texin®, Upjohn Pellethane® from Goodrich, and Desmopan® and Elastollan® from Bayer may find use. It is also possible to use thermoplastic polyetherester elastomers such as Hytrel® from DuPont, Arnitel® from DSM, Ectel® from Eastman, Pipiflex® from Enichem, Lomod® from General Electric, Riteflex® from Celanese, Zeospan® from Nippon Zeon, Elitel® from Elana, and Pelprene® from Toyobo. Use may be made, furthermore, of polyamides such as polyesteramides, polyetheresteram ides, polycarbonateesteramides and polyether-block-amides, from Dow Chemical and Atofina, for example. Also suitable for use are halogenated polyvinyls such as, in particular, soft PVC. It is further possible to employ ionomer-based thermoplastic elastomers such as Surlyn® from DuPont, for example. The mandate for the selection of such materials for carrier systems of products of the invention is agreement with the mandates concerning the optical quality in accordance with this invention.

Further specific examples of thermoplastic polymers which can be used in carriers of products of the invention are semicrystalline polymers. Polyolefins are particularly appropriate in this context. Preferred polyolefins are prepared from ethylene, propylene, butylene and/or hexylene, with the pure monomers able to be polymerized in each case, or mixtures of the stated monomers and further monomers copolymerized. Through the polymerization process and through the selection of the monomers it is possible to control the physical and mechanical properties of the polymeric film, such as the softening temperature and/or the stretchability, for example, and especially the modulus of elasticity. Examples of raw materials which can be used are polyolefins such as ethylene-vinyl acetate (EVA), ethylene-acrylate (EA), ethylene-methacrylate (EMA), low density polyethylene (PE-LD), linear low density polyethylene (PE-LLD), very low density linear polyethylene (PE-VLD), polypropylene homopolymer (PP-H), and polypropylene copolymer (PP-C) (impact or random). Other examples of raw materials for the carrier are soft polyethylene elastomers such as Affinity™ (Dow Chemical), Engage™ (Dow Chemical), Exact™ (Dex Plastomers), Tafmer™ (Mitsui Chemicals), soft polypropylene copolymers such as Vistamaxx™ (Exxon Mobil), Versify™ (Dow Chemical), which have a low melting point as a result of a random structure, and elastomeric heterophase polyolefins (for example with a block structure) such as Infuse™ (Dow Chemical), Hifax™ (Lyondell Basell), Adflex™ (Lyondell Basell) or Softell™ (Lyondell Basell).

In one preferred embodiment of the invention, carriers used are commercially available stretch films or films of the kind employed as “cling films”, being employed either alone or in combination with further films and/or layers, provided the resulting carrier of corresponding products of the invention meets the criteria for the modulus of elasticity and the mandates for the haze value.

Thermoplastic elastomers which can be used with particular advantage for the carrier are block copolymers. Here, individual polymer blocks are linked covalently with one another. Block linkage may be present in a linear form, or else in a star-shaped or graft copolymer variant. One example of an advantageously usable block copolymer is a linear triblock copolymer whose two terminal blocks (known as hard blocks) have a softening temperature of at least 40° C., preferably at least 70° C., and whose middle block (known as soft blocks) has a softening temperature of not more than 0° C., preferably not more than −30° C. Higher block copolymers, tetrablock copolymers for instance, can likewise be employed. It is important that in the block copolymer there are at least two identical or different polymer blocks which have a softening temperature in each case of at least 40° C., preferably at least 70° C. (hard blocks), and which are separated from one another in the polymer chain by at least one polymer block having a softening temperature of not more than 0° C., preferably not more than −30° C. (soft blocks). Examples of polymer blocks are polyethers such as, for example, polyethylene glycol, polypropylene glycol or polytetrahydrofuran, polydienes, such as, for example, polybutadiene or polyisoprene, hydrogenated polydienes, such as, for example, polyethylene-butylene or polyethylene-propylene, polyesters, such as, for example, polyethylene terephthalate, polybutanediol adipate or polyhexanediol adipate, polycarbonate, polycaprolactone, polymer blocks of vinylaromatic monomers, such as, for example, polystyrene or poly-α-methylstyrene, polyalkyl vinyl ethers, polyvinyl acetate, and polymer blocks of α,β-unsaturated esters such as, more particularly, acrylates or methacrylates. The skilled person knows of corresponding softening temperatures. Alternatively he or she looks them up, for example, in the Polymer Handbook [J. Brandrup, E. H. Immergut, E. A. Grulke (eds.), Polymer Handbook, 4^{th} edn. 1999, Wiley, New York]. Polymer blocks may be composed of copolymers.

Specific examples of block copolymers which can be used with particular advantage as thermoplastic elastomers for the carriers of products of the invention are triblock copolymers consisting of polystyrene end blocks and polyisoprene or polybutadiene middle blocks. These middle blocks may be in partly or fully hydrogenated form. Such materials are available for example from a series of manufacturers. Examples are Kraton™ from Kraton, Vector® from Dexco, Taipol® from TSRC, Europrene® from Polimeri Europa, Baling® from Sinopec, Globalprene® from LCY, Quintac® from Nippon Zeon, Solprene® from Dynasol, Tuftec® from Asahi, Septon® from Kuraray, Enprene® from Enchuan, Dynaron® from JSR, Finaprene® from Atofina, Coperflex® from Petroflex, and Styroflex® and Styrolux® from BASF. It is also possible to use triblock copolymers consisting of polystyrene end blocks and polyisobutylene middle blocks, of the kind available as SIBStar® from Kaneka. Also useful with great advantage are triblock copolymers consisting of polymethyl methacrylate end blocks and polybutyl acrylate middle blocks, of the kind obtainable as LA-Polymer® from Kuraray.

In order to produce a carrier it may be appropriate here as well to add additives and further components which enhance the film-forming properties, reduce the tendency toward formation of crystalline segments, adjust the softening temperatures of the soft and/or hard phases, and/or deliberately enhance or else, optionally, impair the mechanical properties. As plasticizers which can optionally be used it is possible to use all of the plasticizing substances known from the technology of self-adhesive tape. These include, among others, the paraffinic and naphthenic oils, (functionalized) oligomers such as oligobutadienes and oligoisoprenes, liquid nitrile rubbers, liquid terpene resins, vegetable and animal fats and oils, phthalates, and functionalized acrylates. It is possible, moreover, to use antistats, antiblocking agents, antioxidants, light stabilizers, and lubricants (see, for example, J. Murphy, The Additives for Plastics Handbook, 1996, Elsevier, Oxford, pp. 2-9).

Combinations of different types of crosslinking, as stated for thermoplastic and nonthermoplastic elastomers, and also other modes of crosslinking known to the skilled person, are likewise encompassed by the present invention in relation to the design of the carriers of double-sidedly pressure-sensitively adhesive products of the invention.

As pressure-sensitive adhesives (PSAs) for the first and second layers of pressure-sensitive adhesive (PSA layers) and also, optionally, for any further PSA layers in double-sidedly pressure-sensitively adhesive products of the invention, it is possible, for the various PSA layers, independently of one another, to employ all linear, star-shaped, branched, grafted or otherwise-designed polymers, preferably homopolymers, random copolymers or block copolymers. Polymers may find use in a pure form or as a mixture with other adjuvants and/or further polymers. Polymer mixtures may be composed of polymers of different kinds in terms of composition, structure and/or molar mass.

The molar mass distribution of suitable polymers for PSAs features a weight-average molecular weight M_{w} of preferably between 150 000 g/mol and 5 000 000 g/mol, very preferably between 250 000 g/mol and 2 000 000 g/mol. The polydispersity, as the quotient of weight-average and number-average molar mass, D=M_{w}/Mₙ, is preferably above 1.5.

Also very suitable are PSAs based on (co)polymers with a multimodal, more particularly a bimodal, molecular weight distribution. Multimodal systems have two or more maxima in their molar mass distribution. By the influence of regulators, for example, it is possible to produce short-chain polymers, which are then formulated in, for example, binary polymer mixtures, in other words mixtures consisting of two solutions or dispersions of polymers with different molecular weights. It is also conceivable, however, to control the molecular weight distribution in a polymerization in such a way that the resulting polymer already, from this single polymerization, is characterized by two or even a greater number of curve maxima in the molecular weight distribution. Synonymously for such polymers or for the aforementioned polymer mixtures, each of these maxima relates to what is called a polymer mode. In the case of two maxima accordingly, the molecular weight distribution is said to be bimodal, or, in simplified form, the polymers are dubbed bimodal. Distributions with more than two maxima are identified, correspondingly, as trimodal in the case of three maxima, and so on. Generally speaking, in the sense of this invention, polymers are termed multimodal when there is more than one curve maximum in their molecular weight distribution.

Where PSAs based on (co)polymers with multimodal molecular weight distribution are employed, the molar mass Mₚ of at least one polymer mode, preferably of the longest-chain polymer mode, is at least 500 000 g/mol, preferably at least 1 000 000 g/mol. In this context it is noted that the molecular weights recited in this disclosure mean those which are obtained via gel permeation chromatography determinations. According to that method, dissolved samples of the (co)polymers in question are separated according to their hydrodynamic volume, and the resulting fractions are detected with a time offset. The molecular weight of the individual fractions is reported after calibration using polystyrene standards. The number average Mₙ corresponds to the first moment of the molecular weight distribution, the weight average M_{w} to the second. These values are determined arithmetically from the measurement curves. Local maxima in the distributions Mₚ(i) for polymer mode i are determined either likewise mathematically, via the evaluating software, or graphically.

It is preferred, moreover, for the softening temperature to be lower than 20° C., preferably lower than 0° C. Softening temperature in this context means the quasi-static glass transition temperature for amorphous systems, and the melting temperature for semicrystalline systems, which may be determined, for example, by means of differential scanning calorimetry measurements. Where numerical values are given for softening temperatures, they relate to the midpoint temperature of the glass stage in the case of amorphous systems, and to the temperature at maximum temperature change rate during the phase transition in the case of semicrystalline systems.

As pressure-sensitive adhesives (PSAs), it is possible to use all of the PSAs known to the skilled person, more particularly acrylate-, natural rubber-, synthetic rubber-, silicone- or ethylene-vinyl acetate-based systems. Combinations of these systems can also be used in accordance with the invention.

Acrylate-based PSAs are employed with great preference. As examples, though without wishing to undertake any restriction, mention may be made, as being advantageous in the sense of this invention, of random copolymers based on nonfunctionalized α,β-unsaturated esters, and random copolymers based on nonfunctionalized alkyl vinyl ethers. Preference is given to using α,β-unsaturated carboxylic acids and their derivatives, of the general structure

CH₂═C(R¹)(COOR²) (I),

where R¹ represents H or CH₃ and R₂ represents H or linear, branched or cyclic, saturated or unsaturated alkyl radicals having 1 to 30, more particularly having 4 to 18, carbon atoms.

Monomers which are used very preferably in the sense of the general structure (I) include acrylic and methacrylic esters with alkyl groups consisting of 4 to 18 C atoms. Specific examples of such compounds, without wishing to impose any restriction through this recitation, are n-butyl acrylate, n-pentyl acrylate, n-hexyl acrylate, n-heptyl acrylate, n-octyl acrylate, n-nonyl acrylate, lauryl acrylate, stearyl acrylate, stearyl methacrylate, the branched isomers thereof, such as 2-ethylhexyl acrylate and isooctyl acrylate, for example, and also cyclic monomers, such as cyclohexyl acrylate or norbornyl acrylate and isobornyl acrylate, for example.

Likewise employable as monomers are acrylate and methacrylate esters which comprise aromatic radicals, such as phenyl acrylate, benzyl acrylate, benzoin acrylate, phenyl methacrylate, benzyl methacrylate or benzoin methacrylate, for example.

Additionally it is possible optionally to use vinyl monomers from the following groups: vinyl esters, vinyl ethers, vinyl halides, vinylidene halides, and also vinyl compounds which comprise aromatic rings or heterocycles in α-position. For the vinyl monomers optionally employable, mention may be made, by way of example, of selected monomers that can be used in accordance with the invention: vinyl acetate, vinylformamide, vinylpyridine, ethyl vinyl ether, 2-ethylhexyl vinyl ether, butyl vinyl ether, vinyl chloride, vinylidene chloride, acrylonitrile, styrene, and α-methyl styrene.

Further monomers which can be employed in accordance with the invention for the PSAs used are glycidyl methacrylate, glycidyl acrylate, allyl glycidyl ether, 2-hydroxyethyl methacrylate, 2-hydroxyethyl acrylate, 3-hydroxypropyl methacrylate, 3-hydroxypropyl acrylate, 4-hydroxylbutyl methacrylate, 4-hydroxybutyl acrylate, acrylic acid, methacrylic acid, itanonic acid and its esters, crotonic acid and its esters, maleic acid and its esters, fumaric acid and its esters, maleic anhydride, methacrylamide and N-alkylated derivatives, acrylamide and N-alkylated derivatives, N-methylolmethacrylamide, N-methylolacrylamide, vinyl alcohol, 2-hydroxyethyl vinyl ether, 3-hydroxypropyl vinyl ether, and 4-hydroxybutyl vinyl ether.

In the case of rubber, or synthetic rubber, as starting material for the PSA, there are further possible variations, from the group, for example, of the natural rubbers or synthetic rubbers, or from any desired blend of natural rubbers and/or synthetic rubbers, it being possible for the natural rubber or natural rubbers to be selected in principle from all available grades such as, for example, crepe, RSS, ADS, TSR or CV types, depending on required purity level and viscosity level, and for the synthetic rubber or synthetic rubbers to be selected from the group of the randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA), and polyurethanes, and/or blends thereof.

Additionally it is possible for rubbers to be admixed, for improving their processing properties, preferably with thermoplastic elastomers, with a weight fraction of 10% to 50% by weight, based on the total elastomer fraction of the PSA used. Representatives that may be mentioned at this point are in particular the especially compatible types polystyrene-polyisoprene-polystyrene (SIS) and polystyrene-polybutadiene-polystyrene (SBS).

Silicone-based PSAs as well can be employed preferably in the sense of this invention. Where PSAs are used which are based on a condensation-crosslinking silicone, they are composed more particularly of the components identified below:
a) a hydroxy-functionalized organopolysiloxane which consists of at least one diorganosiloxane unit,
b) an organopolysiloxane resin with the formula: (R¹₃SiO_{1/2})ₓ(SiO_{4/2})₁, where R¹ is a substituted or unsubstituted monovalent hydrocarbon group, a hydrogen atom or a hydroxyl group, and x is a number between 0.5 and 1.2,
c) optionally a stabilizer,
d) optionally an initiator.

Silicone PSAs of this kind are freely available commercially. Examples that may be mentioned at this point include the following: DC 280, DC 282, Q2-7735, DC 7358, Q2-7406 from Dow Corning, PSA 750, PSA 518, PSA 910, PSA 6574 from Momentive Performance Materials, KRT 001, KRT 002, KRT 003 from ShinEtsu, PSA 45559 from Wacker Silicones, and PSA 400 and PSA 401 from BlueStar Silicones.

Employed alternatively as PSAs are those based on an addition-crosslinked silicone composed of the components identified below:
a) an organopolysiloxane which consists of at least one diorganosiloxane unit and carries at least two silicon-bonded alkenyl groups in each molecule,
b) an organopolysiloxane resin having the formula: (R¹₃SiO_{1/2})ₓ(SiO_{4/2})₁, where R¹ is a substituted or unsubstituted monovalent hydrocarbon group, a hydrogen atom or a hydroxyl group and x is a number between 0.5 and 1.2,
c) an organopolysiloxane which carries on average at least two silicon-bonded hydrogen atoms in each molecule, in an amount such that there are 0.01 to 10 mol of silicon-bonded hydrogen atoms per mole of the total alkenyl groups of components a), b), and e), and which is free from olefinic double bonds,
d) an organometallic catalyst from group 10 of the periodic table of the elements, and
e) optionally an inhibitor.

Silicone PSAs of this kind are freely available commercially. Examples that may be mentioned here include the following: DC 7657 and DC 2013 from Dow Corning and KR 3700 and KR 3701 from ShinEtsu.

In order to obtain the desired adhesive properties, the silicone formulations described are admixed with what are called MQ resins, with the formula (R¹₃SiO_{1/2})ₓ(SiO_{4/2})₁. The M unit therein is denoted by the (R¹₃SiO_{1/2}) units, the Q unit by the (SiO_{4/2}) units. Each R¹ independently of any other represents a monovalent saturated hydrocarbon group, a monovalent unsaturated hydrocarbon group, a monovalent halogenated hydrocarbon group, a hydrogen atom or a hydroxyl group. The ratio of M units to Q units (M:Q) is preferably in the range from 0.5 to 1.2.

The MQ resins are advantageously those having a weight-average molecular weight M_{w} of 500 g/mol≦M_{w}≦100 000 g/mol, preferably of 1 000 g/mol≦M_{w}≦25 000 g/mol.

It has emerged as being advantageous if adhesives are used in which the proportional ratio—based on percent by weight—of polydiorganosiloxane to MQ resin is in the range from 20:80 to 80:20, preferably in the range from 30:70 to 60:40.

MQ resins of this kind are freely available commercially. Examples that may be mentioned here include the following: SL 160, SL 200, and DC 2-7066 from Dow Corning, SR 545, SR 1000, and 6031 SL from Momentive Performance Materials, and CRA 17, CRA 42, and MQ-Harz 803 from Wacker.

In addition to the resin modification it is also possible to add further additives to the silicone-based PSA. Further additives which can be utilized include the following:
in-process stabilizers, such as, for example, vinylsilanes or alkynols as inhibitors for the platinum catalyst
process accelerants such as, for example, aminoorganyls
fillers, such as, for example, silicon dioxide, glass (ground or in the form of beads), aluminum oxides or zinc oxides, the fillers being more particularly so finely ground or otherwise prepared that they are optically invisible
optionally, further polymers, preferably elastomeric in nature; elastomers which can be utilized accordingly include, among others, those based on pure hydrocarbons, examples being unsaturated polydienes, such as natural or synthetically produced polyisoprene or polybutadiene; chemically substantially saturated elastomers, such as, for example, saturated ethylene-propylene copolymers, α-olefin copolymers, polyisobutylene, butyl rubber, ethylene-propylene rubber, and also chemically functionalized hydrocarbons, such as, for example, halogen-containing, acrylate-containing or vinyl ether-containing polyolefins, to name but a few
plasticizers, such as, for example, liquid resins, plasticizer oils or low molecular mass liquid polymers, such as, for example, low molecular mass silicone oils having molar masses<1500 g/mol (number average).

In order to achieve sufficient cohesion, the condensation-crosslinking silicone PSAs are preferably compounded with peroxo initiators. Used with particular preference for this purpose is benzoyl peroxide (BPO). The peroxo initiators are used more particularly in an amount of 0.2% to 5% by weight, based on the solids fraction of the silicone adhesive. In order to obtain a reasonable measure between cohesion and adhesion, a BPO content of 0.5% to 2% by weight is selected more particularly. Where the adhesive is coated from solvent, a temperature of 70-90° C. is selected first of all, for at least two minutes, in order for the solvents to evaporate. Subsequently a temperature of 170-180° C. is set for at least two minutes, in order to initiate the disintegration of the peroxide and hence the process of crosslinking.

Achieving a sufficient cohesion for addition-crosslinking silicone adhesives is accomplished more particularly by a platinum-catalyzed hydrosilylation reaction between the alkenyl-functionalized organopolysiloxanes and the corresponding SiH functionalized organopolysiloxanes. In this case, with coating from solution, the solvent is first of all removed at a temperature of 70-90° C. and a residence time of at least two minutes. Subsequently the temperature is raised to 100-120° C. and is kept constant for up to two minutes.

In addition to the conventional modes of crosslinking of silicone PSAs, by means of peroxides or transition metal catalysis, it is also possible for these adhesives to be crosslinked by actinic radiation, especially electron beams. In this case, with coating from solution, the solvent is first of all removed at a temperature of 70-90° C. and a residence time of at least two minutes. This is followed by crosslinking with an electron beam dose of at least 10 kGy. This type of crosslinking is especially advantageous, since it allows the cohesion to be set almost infinitely, without adversely influencing the properties of tack and adhesion.

As plasticizers, which are possible for optional use, it is possible to use all plasticizing substances that are known from self-adhesive tape technology. These include, among others, the paraffinic and naphthenic oils, (functionalized) oligomers such as oligobutadienes and oligoisoprenes, liquid nitrile rubbers, liquid terpene resins, vegetable and animal fats and oils, phthalates, and functionalized acrylates. PSAs as indicated above may, moreover, comprise additional constituents besides the stated optional plasticizers, such as additives with rheological activity, catalysts, initiators, stabilizers, compatibilizers, coupling reagents, crosslinkers, antioxidants, other aging inhibitors, light stabilizers, flame retardants, pigments, dyes, fillers and/or expandants, and also, optionally, solvents.

As tackifying resins which can optionally be used it is possible, in combination with the stated and other adhesive base polymers or base polymer mixtures, to use, without exception, all known tackifier resins described in the literature. Representatives that may be mentioned are the rosins, their disproportionated, hydrogenated, polymerized, and esterified derivatives and/or salts, the aliphatic and aromatic hydrocarbon resins, terpene resins and terpene-phenolic resins. Any desired combinations of these and further resins may be used in order to adjust the properties of the resultant adhesive in accordance with requirements. Further polymers may likewise be used, especially with the purpose of adjusting the properties of the soft phases and/or any hard phases in accordance with requirements. For example, by adding a hard-block-compatible resin/polymer, it is possible to raise the proportion of the hard phase in the mixture as a whole.

PSAs of the kind indicated above may further comprise additional constituents such as additives with rheological activity, catalysts, initiators, stabilizers, compatibilizers, coupling reagents, crosslinkers, antioxidants, other aging inhibitors, light stabilizers, flame retardants, pigments, dyes, fillers and/or expandants, and also, optionally, solvents.

In one particular embodiment of the invention, the different layers/plies of double-sidedly pressure-sensitively adhesive products of the invention, are harmonized with one another through selection of formulating constituents and/or through selection of the composition of individual constituents—in other words, in the simplest embodiment, through the choice of the carrier, of the first PSA layer, and of the second PSA layer—in such a way that the refractive indices of the individual layers differ from one another as little as possible. The lower the difference in refractive index between layers in contact with one another, the lower the loss of transmitted light through interfacial reflection. A refractive index difference of less than 0.1, more particularly of less than 0.01, is advantageous and can be realized, to give just a single, nonlimiting example, through the choice of pressure-sensitive adhesive layers based on acrylate copolymers of aliphatic kind, and of a carrier layer likewise based on acrylate copolymers of aliphatic kind.

In order to protect the pressure-sensitively adhesive surfaces against contamination and unwanted premature bonding up until the time of use, they are typically lined temporarily with redetachable auxiliary carrier materials, referred to as release liners. Where the double-sidedly pressure-sensitively adhesive products are in the form of sheet product, then a sheet of a release liner material is used to line the underside, and a second such sheet for the top side. Where the double-sidedly pressure-sensitively adhesive products are converted in roll form, then it is likewise possible for two release liner materials to be employed, or else a single sheet, which is prepared on its front and reverse faces in such a way that at the time of the application of the self-adhesive product it can be detached first from one pressure-sensitively adhesive surface and subsequently from the second.

Double-sidedly pressure-sensitively adhesive products of the invention therefore carry a first and a second release layer and also an assembly arranged between them and comprising at least one carrier layer and two pressure-sensitive adhesive layers. Where the release layers are release layers of different release liners, the liners used may differ in shape and/or size. For example, one release liner may protrude in its dimensions beyond the self-adhesive assembly and the other release liner. Likewise conceivable is a product construction in which the release liners have the same shape and/or size and protrude in shape and/or size beyond the self-adhesive assembly. In one embodiment the double-sidedly pressure-sensitively adhesive product may be designed in a form corresponding to a label web. Thus, for example, a first release liner may be designed in web form, while the self-adhesive assembly is applied thereto in the form of repeating sections (similarly label-shaped) which are individualized, for example, by diecutting. The second release liner may then likewise be limited only to repeating sections in the region of the self-adhesive assembly, or may have a shape and/or size corresponding substantially to the shape and/or size of the first release liner. In the latter case, however, in one advantageous embodiment, diecuts are provided in the second release liner in the region of the PSA areas.

Typically, release liners are composed of a carrier film which is equipped on one or both sides with a release varnish preferably based on silicone. A preferred embodiment of this invention uses polyolefins as carrier material for the release liners. Preferred polyolefins are prepared from ethylene, propylene, butylene and/or hexylene, it being possible in each case to polymerize the pure monomers or to copolymerize mixtures of the stated monomers. Through the polymerization process and through the selection of the monomers it is possible to direct the physical and mechanical properties of the polymeric film, such as the softening temperature and/or the tensile strength, for example. One particularly preferred embodiment of this invention employs polyesters based on polyethylene terephthalate (PET) as carrier material for the release liners. In particular, specific high-transparency PET films can be used. Thus, for example, suitability is possessed by films from Mitsubishi with the trade name Hostaphan™ or from Toray with the trade name Lumirror™ or from DuPont Teijin with the trade name Melinex™.

Furthermore, various papers, optionally also in combination with a stabilizing extrusion coating, are suitable as carrier material for release liners. All of the stated release liners acquire their antiadhesive properties by means of one or more coating passes, for example, but preferably, with a silicone-based release. Application may take place on one or both sides.

Release liners may, moreover, carry a fluoro-siliconization as release medium. This is advantageous more particularly for lining silicone-based PSA layers. Besides fluoro-silicone systems, coatings of fluorinated hydrocarbons on release liners are also contemplated with preference.

All of the approaches familiar to the skilled person for setting the release properties of the release layers can be employed in principle in the sense of this invention. Compilations of control possibilities are collated by Satas, Kinning and Jones [D. Satas in “Handbook of Pressure Sensitive Adhesives Technology”, D. Satas (ed.), 3rd edn., 1999, Satas & Associates, Warwick, pp. 632-651; D. J. Kinning, H. M. Schneider in “Adhesion Science and Engineering—Volume 2: Surfaces, Chemistry & Applications”. M. Chaudhury, A. V. Pocius (ed.), 2002, Elsevier, Amsterdam, pp. 535-571; D. Jones, Y. A. Peters in “Handbook of Pressure Sensitive Adhesives Technology”, D. Satas (ed.), 3rd edn., 1999, Satas & Associates, Warwick, pp. 652-683]. This is important in the case of double-sided release liners or in the case of product designs with two release liners. For good handling properties, the release forces of the two release layers must be graduated.

The double-sidedly pressure-sensitively adhesive products which are used in the method of the invention are double-sided adhesive tapes, labels or sheets.

The coatweights of the at least one first and at least one second and of any desired further pressure-sensitive adhesive layers may be selected independently of one another. They are between 1 g/m² and 500 g/m², more particularly between 10 g/m² and 250 g/m².

If more than one pressure-sensitive adhesive layer is employed, the layers may be the same or different in terms of chemistry, formulation and/or crosslinking status. As an example of a combination for different types of PSA which can be combined in a double-sidedly pressure-sensitively adhesive product, mention may be made of a system consisting of an acrylate-based pressure-sensitive adhesive layer and a silicone-based pressure-sensitive adhesive layer.

Where two release liners are employed for lining, their thickness may be the same or different. It is preferred to use two release liners of different thicknesses. With great preference, in the context of the production of the double-sidedly pressure-sensitively adhesive products, the pressure-sensitive adhesive layer which is to be bonded first to the target substrate is lined with the thinner release liner after coating and drying. In this scenario, the thicker release liner is preferably coated directly with the adhesive for the pressure-sensitive adhesive layer that is to be bonded second.

The release layers in release liners A and B, or topside and underside in double-sided release liners, may be selected independently of one another in relation to raw materials class, crosslinking mode, degree of crosslinking, formulation, physical pretreatment, chemical pretreatment and/or coatweight, and also in relation to any structuring.

Release liners provided double-sidedly with release layers preferably have a thickness of at least 20 μm and of less than 150 μm. For release liners furnished with release layer on one side, the same range of values is preferred.

Where release liner combinations are employed, the thicknesses of release liner A and release liner B may be the same or different. Suitable release liner thicknesses are again between 20 μm and 150 μm. Particularly advantageous release liner thickness combinations consist of release liners having thicknesses in the range from in each case 30 μm to 80 μm. Particularly advantageous release liner thickness combinations are 36 μm (thickness of release liner A) and 50 μm (thickness of release liner B) or vice versa, and also 50 μm and 75 μm or vice versa.

The at least one carrier layer is preferably cast from solution or aqueous dispersion. Suitable methods for accomplishing this are all of those known from the prior art. However, solvent-free methods are conceivable as well, provided they allow the demanding optical properties of the carrier material to be achieved. The skilled person knows of methods which can be employed successfully in this sense, examples being those which make use of polished surfaces as web-guiding or adhesive-film-guiding elements such as rolls in particular. Very suitable indeed are also multiple-component methods, e.g., two-component methods. Where the reactive components used are formulated such that their viscosity is low enough at the working temperature, then an outstanding coating pattern can be generated in corresponding methods even without solvent. As an example of a corresponding adhesive system and method concept, mention may be made of U.S. Pat. No. 7,605,212 B2 of tesa SE. These and further methods are also known, for example, from the polyurethanes sector.

Double-sidedly pressure-sensitively adhesive products of the invention can be produced by methods which are known per se. Different sequences of coating and laminating operations are conceivable and can be employed advantageously. Mention may be made here of just one example which is very suitable. According to this example, a first release liner web is coated first with a first PSA. Advantageously this takes place with a solvent-containing formulation which is subsequently dried. The PSA is preferably selected such that its crosslinking occurs at least partly during the drying operation. It may be advantageous for the crosslinking operation to be at an end at the end of the drying operation. Subsequently a carrier web is laminated on and the resulting intermediate is wound up. This intermediate is laminated with a second pressure-sensitive adhesive layer, coated beforehand onto a second release liner web. Advantageously this takes place with a solvent-containing formulation which is subsequently dried. The PSA will preferably be selected such that its crosslinking takes place at least partly during the drying operation. It can be advantageous for the crosslinking operation to be at an end at the end of the drying operation.

If the carrier layer is cast from solution, this operation takes place advantageously on a process liner. After drying, the web may be lined with a further process liner or, if the first process liner is equipped for reverse-face release, the web may be wound up onto itself. For further processing in the laminating operation indicated above, this carrier layer web is unwound and then first one of the process liners is removed. This side, which is then open, is laminated with the open pressure-sensitive adhesive layer.

Product in bale form can be subsequently converted as desired—for example, slit into stock rolls or strips, or slit, diecut or length-separated to form sheets. The skilled person is aware of other methods for producing double-sidedly self-adhesive products such as adhesive tapes, labels, and sheets, such methods being likewise useful for products of the invention.

Double-sidedly self-adhesive products of the invention are suitable for the connective bonding of two objects. Great preference is given to their use in bonding tasks where particularly high optical quality in the adhesive bond is important. These include adhesive bonds between optical components and/or films of all kinds, such as, for example, in displays, but also in large-area glass bonds. The present invention accordingly likewise relates to the use of the stated products for the adhesive bonding of transparent substrates.

On the basis of the high layer thickness accessible, double-sidedly self-adhesive products of the invention are outstandingly suitable for compensating topographical features in the substrates to be bonded, during the bonding operation, such as waviness, roughness, curvature, bending, and structurings of any kind. Their use for this purpose is likewise part of this invention.

At the same time, double-sidedly self-adhesive products of the invention with a high layer thickness are more suited, furthermore, to the lamination especially of rigid substrates such as optical lenses. The present invention relates to the use of double-sidedly self-adhesive products of the invention for this purpose.

With particular advantage, double-sidedly self-adhesive products of the invention prove not only to offer outstanding laminating and surface compensation properties but also, at the same time, nevertheless and surprisingly, to have very good slitting and diecutting qualities, allowing diecuts to be produced readily from sheets of double-sidedly self-adhesive products of the invention. Accordingly, diecut laminating films obtainable from double-sidedly pressure-sensitively adhesive products of the invention are part of this invention.

### Test Methods

### Test Method A—Modulus of Elasticity:

The modulus of elasticity indicates the mechanical resistance opposed by a material to an elastic deformation. It is defined as the ratio of the required stress σ to the achieved strain ε, where ε is the ratio of length change ΔL and of length L₀ in the Hooke deformation regime of the specimen. The definition of the modulus of elasticity is explained for example in Taschenbuch der Physik (H. Stöcker (ed.), Taschenbuch der Physik, 2^{nd} edn., 1994, Verlag Harri Deutsch, Frankfurt, pp. 102-110).

For the determination of the elasticity modulus, the tensile strain behavior of the test specimens was first of all determined on type 2 testing specimens (pressure-sensitively adhesive products in the form of rectangular test strips with a length of 150 mm and a width of 15 mm) in accordance with DIN EN ISO 527-3/2/300, with a test speed of 300 mm/min, a clamped length of 100 mm, and a pretensioning force of 0.3 N/cm, with specimens having been trimmed to size with sharp blades for the purpose of determining the data. A Zwick tensile testing machine (model Z010) was employed. The tensile strain behavior was measured in the machine direction (MD). A 1000 N (Zwick Roell Kap-Z 066080.03.00) or 100 N (Zwick Roell Kap-Z 066110.03.00) load cell was used. The modulus of elasticity was determined graphically from the measurement plots, by a determination of the slope of the initial portion of the plot, the portion which is characteristic for Hookean behavior, and was reported in MPa.

### Test Method B—Haze (Large-Angle Scattering), Transmission:

The determination of transmission and haze took place in accordance with ASTM D1003 on a haze-gard plus from Byk-Gardner. The procedure of ASTM D1003 was followed, with specimens of the double-sided pressure-sensitively adhesive products first being freed from their release liners and applied to the specimen holder.

### Test Method C—Adhesive Oozing Test:

The test was carried out using adhesive tape specimens still lined on both sides with release liners (siliconized PET film 50 μm in each case). From the samples, circular diecuts with a diameter of 29 mm were produced and were placed between two projecting plies of a transparent PET film. This construction is loaded with a force of 800 N for 30 seconds in a hot press at 80° C. After cooling, the testing specimens are inspected visually with the aid of a slide gauge (accuracy±0.05 mm). The outer diameter of the testing specimens resulting from the pressing operation was measured. The area ratios (initial area Aᵢₙᵢₜᵢₐₗ, final area A_{final}) can be used to calculate the oozing ratio OR, using the following formula:

OR=[(A_{final}−Aᵢₙᵢₜᵢₐₗ)/Aᵢₙᵢₜᵢₐₗ]*100%

### Test Method D—Laminating Behavior:

Specimens of double-sidedly pressure-sensitively adhesive products were freed from a release liner and laminated to the printed side of a transparent PET film using a rubberized manual roller, the printing consisting of a black, opaque, full-area printed layer with a printing thickness of 10 μm, containing circular voids of different diameters (0.18 mm, 0.20 mm, 0.30 mm, 0.40 mm, 0.50 mm, 0.60 mm, 0.70 mm, 0.80 mm, 0.90 mm, 1.0 mm). During the laminating operation, care was taken to ensure that the manual roller was always applied only in one direction; laminating using the manual roller in opposite directions was not done. Subsequently the second release liner was removed and the assembly was laminated onto a transparent polycarbonate sheet 3 mm thick. The laminates were subsequently inspected in the area of the voids in the printing, through the PET film, using a light microscope (NSK Japan, Nissho Optical Co., Ltd., TZ-240 010/24T, magnification 10 times to 60 times). The existence of any air bubbles within the circular printing voids was utilized for the purpose of qualifying the laminating outcome. For quantifying and distinguishing different test specimens, an indication is made of the smallest circle diameter which is still completely filled out with adhesive and is bubble-free.

### Test Method E—Refractive Index:

The refractive index was measured using the Optronic instrument from Krüss at 25° C. with white light (λ\, =550 nm±150 nm) in accordance with the Abbe principle. For temperature stabilization, the instrument was operated in conjunction with a thermostat from Lauda. Pressure-sensitive adhesive layer specimens were produced by coating adhesive onto a release liner, drying it, and lining the applied layer with a second release liner. For the measurement, both release liners were removed. To produce the carrier layer specimens, the initial formulation was coated onto a release liner and dried. For the measurement, the release liner was removed. In the case of the carrier layer specimens in sheet form, a section of this material was subjected to measurement without further pretreatment. On each sample, the measurements were carried out three times; the values obtained were averaged.

### EXAMPLES

### Example 1

A polyacrylate with a 7% by weight acrylic acid fraction in the copolymer and with a Fikentscher k value [P. E. Hinkamp, Polymer, 1967, 8, 381] of 55 was crosslinked with 0.6% by weight (based on the solids content of the polymer) of aluminum chelate and was coated by a doctor blade method, as a 31% strength by weight solution in a mixture of acetone/benzene/ethyl acetate, onto a release liner A (first release layer), dried first for 20 minutes at room temperature and then for 15 minutes at 120° C., and lined with release liner B (second release liner). The layer thickness of the resulting pressure-sensitive adhesive layer after drying was 50 μm. The design corresponded to that of an adhesive transfer tape. Release liner A used was a siliconized 50 μm PET film-based system. Release liner B used was a siliconized 36 μm PET film-based system, with easier release in relation to release liner A. The PSA layers obtained in this way were subjected to test E.

A carrier material was produced by coating a solution of a thermoplastic elastomer (LA 4285 from Kuraray) onto a siliconized 50 μm PET process liner. The layer thickness of the carrier after drying was 125 μm. Specimens of this carrier material without process liner were subjected to test A, using the 100N load cell, and to test E.

Following removal of the 36 μm liner (release liner B), the adhesive transfer tape was laminated onto the open side of the carrier layer, using a rubberized manual roller. Then the process liner was removed and a second ply of an adhesive transfer tape, freed from the 36 μm liner (release liner B), was laminated on. The complete adhesive tape without liner had a layer thickness of 225 μm. Test specimens of this kind were subjected to tests B, C and D.

### Example 2 (Comparative Example)

A polyacrylate with a 7% by weight acrylic acid fraction in the copolymer and with a Fikentscher k value [P. E. Hinkamp, Polymer, 1967, 8, 381] of 55 was crosslinked with 0.6% by weight (based on the solids content of the polymer) of aluminum chelate and was coated by a doctor blade method, as a 31% strength by weight solution in a mixture of acetone/benzene/ethyl acetate, onto a release liner A (first release layer), dried first for 20 minutes at room temperature and then for 15 minutes at 120° C., and lined with release liner B (second release liner). The layer thickness of the pressure-sensitive adhesive layer after drying was 50 μm. The design corresponded to that of an adhesive transfer tape. Release liner A used was a siliconized 50 μm PET film-based system. Release liner B used was a siliconized 36 μm PET film-based system, with easier release. The PSA layers obtained in this way were subjected to test E.

A carrier material was produced as follows: A polyacrylate with a 3% acrylic acid fraction in the copolymer and with a Fikentscher k value [P. E. Hinkamp, Polymer, 1967, 8, 381] of 70 was crosslinked with 0.6% by weight (based on the solids content of the polymer) of aluminum chelate and was coated by a doctor blade method, as a 31% strength by weight solution in a mixture of acetone/benzene/ethyl acetate, onto a release liner A (first release layer), dried first for 20 minutes at room temperature and then for 15 minutes at 120° C., and lined with release liner B (second release liner). This polymer system had been made pressure-sensitively adhesive by means of its composition, molar mass distribution, and crosslinking. The layer thickness of this layer after drying was 125 μm. The design corresponded to that of an adhesive transfer tape. Release liner A used was a siliconized 50 μm PET film-based system. Release liner B used was a siliconized 36 μm PET film-based system, with easier release.

Specimens of this very soft carrier material without process liner were subjected to test A, using the 100N load cell, and to test E.

Following removal of the 36 μm liner, the adhesive transfer tape was laminated, using a rubberized manual roller, to the side of the pressure-sensitively adhesive carrier layer which had been freed from the 36 μm release liner. Subsequently the 50 μm release liner was removed from the pressure-sensitively adhesive carrier layer, and a second ply of an adhesive transfer tape, freed from the 36 μm release liner. The complete adhesive tape without liner had a layer thickness of 225 μm. Test specimens of this kind were subjected to tests B, C and D.

### Example 3 (Comparative Example)

A polyacrylate with a 7% by weight acrylic acid fraction in the copolymer and with a Fikentscher k value [P. E. Hinkamp, Polymer, 1967, 8, 381] of 55 was crosslinked with 0.6% by weight of aluminum chelate and was coated by a doctor blade method, as a solution, onto a release liner A (first release layer), dried first for 20 minutes at room temperature and then for 15 minutes at 120° C., and lined with release liner B (second release liner). The layer thickness of the resulting pressure-sensitive adhesive layer after drying was 50 μm. The design corresponded to that of an adhesive transfer tape. Release liner A used was a siliconized 50 μm PET film-based system. Release liner B used was a siliconized 36 μm PET film-based system, with easier release. PSA layers were subjected to test E. The carrier layer used was a 125 μm PET film having a haze of about 1%. Specimens of this carrier system were subjected to test A, using the 1000N load cell, and to test E. Following removal of the 36 μm liner, the adhesive transfer tape was laminated, using a rubberized manual roller, to a first side of the carrier film. Subsequently, a second ply of an adhesive transfer tape freed from the 36 μm was laminated onto the second side of the carrier film. The complete adhesive tape without liner had a layer thickness of 225 μm. Test specimens of this kind were subjected to tests B, C and D.

### Example 4 (Comparative Example)

A polyacrylate with a 7% by weight acrylic acid fraction in the copolymer and with a Fikentscher k value [P. E. Hinkamp, Polymer, 1967, 8, 381] of 55 was crosslinked with 0.6% of aluminum chelate and was coated by a doctor blade method, as a solution, onto a release liner A (first release layer), dried first for 20 minutes at room temperature and then for 15 minutes at 120° C., and lined with release liner B (second release liner). The layer thickness of the pressure-sensitive adhesive layer after drying was 225 μm. The design corresponded to that of an adhesive transfer tape. Release liner A used was a siliconized 50 μm PET film-based system. Release liner B used was a siliconized 36 μm PET film-based system, with easier release. Adhesive tapes of this kind contained no further carrier system and therefore corresponded to the design of an adhesive transfer tape.

Test specimens of this kind were subjected to tests A (100N load cell), B, C, D and E.

TABLE 1

| | Example 1 | Example 2 | Example 3 | Example 4 |
|---|---|---|---|---|
| | (invention) | (reference) | (reference) | (reference) |
| Pressure-sensitive | 50 μm polyacrylate | 50 μm polyacrylate | 50 μm polyacrylate | 225 μm polyacrylate |
| adhesive layer 1 | | | | |
| Carrier layer | 125 μm inventive | 125 μm pressure-sensitively | 125 μm PET film | none |
| | elastic carrier | adhesive polyacrylate | | |
| Pressure-sensitive | 50 μm polyacrylate | 50 μm polyacrylate | 50 μm polyacrylate | none |
| adhesive layer 2 | | | | |
| Test method | | | | |
| A Modulus of elasticity | 318 MPa | not measurable | 3450 MPa | not measurable |
| B Haze | 0.94% | 0.54% | 1.62% | 0.14% |
| B Transmission | 94.9% | 94.9% | 93.8% | 94.9% |
| C Oozing | 5% | 14% | 2% | 15% |
| D Laminating behavior | 0.4 mm | <0.18 mm | 0.8 mm | <0.18 mm |
| E Refractive index | 1.474 | 1.474 | 1.474 | 1.474 |
| adhesive layer 1&2 | | | | |
| E Refractive index | 1.480 | 1.476 | 1.650 | -/- |
| carrier layer | | | | |

Table 1 summarizes the results of investigation of the test specimens produced according to examples 1 to 4. For optically high-grade, double-sidedly pressure-sensitively adhesive products, a tendency toward adhesive oozing that is in principle as low as possible is expected in order to ensure good handling properties and further processing properties. Oozing values of more than 10% are already enough to cause marked side-edge stickiness, and are therefore deleterious. At the same time, optically high-grade, double-sidedly pressure-sensitively adhesive products are required to have very good laminating properties, a requirement which is diametrically opposed to the aforementioned requirements. The laminatability according to test D, expressed by the smallest diameter of a circular void in the printed image that is still just filled out with adhesive in a laminating operation without any air bubbles, ought as far as possible to be as good (the diameter to be as small) as possible. The smaller the value given, the better the ability of a pressure-sensitively adhesive product to compensate topographical height differences, without any air inclusions (bubble formation) in the region of the transitions of raised areas, and hence without any detrimental effect on optical quality.

The modulus of elasticity could not be measured for all of the product constructions. Double-sidedly pressure-sensitively adhesive products according to example 2 and example 4 could not be freed in sufficient quality from the second release liner in order to allow them to be investigated for their elasticity modulus in accordance with test A. This of itself is already a qualitative indication of inadequate modulus of elasticity. The force required to stretch these double-sidedly pressure-sensitively adhesive products is evidently of an order of magnitude, or even below that, of the release force required to detach the adhesive layer from the second release liner (this force being 0.02 N/mm).

It is found that test specimens according to the invention meet the stated requirements, whereas non-inventive test specimens are not capable of compensating topographical height differences and at the same time of avoiding the critical oozing behavior.

1. A process for adhesive bonding of optical components comprising applying a double-sided pressure-sensitive adhesive product to optical components,
wherein the adhesive product comprises,
(i) a carrier having a first surface and a second surface, and
(ii) a first layer of pressure-sensitive adhesive, disposed on the first surface of the carrier, and
(iii) a second layer of pressure-sensitive adhesive, disposed on the second surface of the carrier,
and wherein the carrier has a modulus of elasticity of 2.5-500 MPa, and the adhesive product has a haze value of 5% or less as measured by ASTM D1003.

2. The process of claim 1, wherein the carrier has a modulus of elasticity of 5-250 MPa.

3. The process of claim 1, wherein the difference in the refractive indices of the first and second layers of pressure-sensitive adhesive in relation to the refractive index of the carrier is in each case less than 0.1.

4. (canceled)

5. The process of claim 1, wherein the optical components have topographical height differences of more than 100 μm.

6. (canceled)

7. The process of claim 1, wherein at least one of the optical components is transparent.

8. The process of claim 1, wherein the carrier has a layer thickness of between 100 μm to 1000 μm.

9. The process of claim 1, wherein the carrier has a layer thickness of between 250 μm to 500 μm.

10. The process of claim 1, wherein the carrier has a layer thickness of between 125 μm to 250 μm.

11. The process of claim 1, wherein the carrier is made from a non-thermoplastic elastomer.

12. The process of claim 1, wherein the carrier is made from a thermoplastic elastomer selected from the group consisting of semicrystalline polymers, polyolefins, ethylene-vinyl acetate (EVA), ethylene-acrylate (EA), ethylene-methacrylate (EMA), low density polyethylene (PE-LD), linear low density polyethylene (PE-LLD), very low density linear polyethylene (PE-VLD), polypropylene homopolymer (PP-H), impact or random polypropylene copolymer (PP-C), soft polyethylene elastomers, soft polypropylene copolymers, and elastomeric heterophase polyolefin.

13. The process of claim 1, wherein the carrier is selected from the group consisting of crosslinked (meth)acrylate copolymer-based elastomers.

14. The process of claim 1, wherein the carrier comprises a (meth)acrylate block copolymer.

15. The process of claim 1, wherein the carrier comprises a polymethylmethacrylate-polybutylacrylate-polymethylmethacrylate block copolymer.
